(19) United States
(12) Patent Application Publication
(10) Pub. No.: US 2021/0153244 A1
(43) Pub. Date: May 20, 2021

(54) USER EQUIPMENT AND RANDOM ACCESS CONTROL METHOD

(71) Applicant: NTT DOCOMO, INC., Tokyo (JP)

(72) Inventors: Tomoya Ohara, Tokyo (JP); Hiroki Harada, Tokyo (JP); Ryosuke Osawa, Tokyo (JP)

(73) Assignee: NTT DOCOMO, INC., Tokyo (JP)

(21) Appl. No.: 16/621,558

(22) PCT Filed: Jun. 15, 2017
(86) PCT No.: PCT/JP2017/022234

§ 371 Date: Dec. 11, 2019

(51) Int. Cl. H04W 74/00; H04W 74/08; H04W 52/36

(52) U.S. Cl. CPC H04W 74/008; H04W 52/36; H04W 74/0833

(57) ABSTRACT

A user equipment in one embodiment of the present invention includes a random access control unit for deciding whether a condition that same transmission power is usable when changing a transmission beam and retransmitting a preamble is satisfied, and determining transmission power of the preamble based on the deciding, and a transmission unit for transmitting the preamble using the determined transmission power.

### TECHNICAL FIELD

The present invention relates to a user equipment and a random access control method.

### BACKGROUND ART

In 3GPP (Third Generation Partnership Project), next-generation communication standards (5G or NR) of LTE (Long Term Evolution) and LTE-Advanced are discussed. In NR systems, it is assumed that a random access is made, similarly as in the case of LTE or the like, when a user equipment UE establishes a connection or makes a reconnection with a base station (eNB or eNodeB).

In the random access of the LTE, the user equipment UE transmits a preamble (PRACH preamble) selected from among a plurality of preambles prepared within a cell. When the preamble is detected, the base station eNB transmits RAR (RACH response) that is response information to the detected preamble. The user equipment UE that receives the RAR transmits RRC Connection Request as message3. After receiving the message3, the base station eNB transmits Connection Setup including cell configuration information or the like for establishing a connection, as message4. The user equipment UE having its own UE ID included in the message4 completes a random access process, and the connection is established.

In the LTE, when the user equipment UE does not receive the RAR as the response information after transmitting the preamble, the user equipment UE retransmits the preamble according to a retransmission scheme called power ramping that increases transmission power at a predetermined step (refer to Non-Patent Documents 1 and 2).

### PRIOR ART DOCUMENTS

### Non-Patent Documents

Non-Patent Document 1: 3GPP TS36, 321 V14.2.1 (2017-03)

Non-Patent Document 2: 3GPP TS36, 213 V14.2.0 (2017-03)

### DISCLOSURE OF THE INVENTION

### Problem to be Solved by the Invention

In the NR system, it is assumed that transmission beam forming is applied for the transmission of the preamble. Due to the application of the transmission beam forming, it is assumed that a retransmission scheme called beam switching, according to which a transmission beam different from that of a previous transmission is used for retransmission, is used as a retransmission scheme for the preamble, in addition to the power ramping. In the case where retransmission is made with the same transmission beam as that of the previous transmission, it is assumed, as a general rule, that the power ramping is applied. In addition, in the case where the beam switching is applied when making retransmission, it is assumed, as a general rule, that the power ramping is not performed.

The beam switching has advantageous features in that power consumption of the user equipment UE can be reduced compared to the power ramping, interference to other user equipments can be reduced, or the like. However, in the case where the transmission beam continues to be changed by placing higher priority on the beam switching than the power ramping when the user equipment retransmits the preamble, the transmission power of the user equipment does not increase, and the preamble may not reach the base station in some cases. For example, in an environment in which a characteristic difference for each transmission beam is not large, the preamble will not reach the base station unless the power ramping is used.

Changing the transmission beam not only includes changing a direction of the transmission beam, but also includes slightly narrowing the transmission beam by digital beam forming while a general direction of the transmission beam remains the same, for example. For this reason, depending on the user equipment, the transmission beam may continue to be changed before performing the power ramping, and in the environment in which the characteristic difference for each transmission beam is not large, a number of retransmissions of the preamble increases. In order to reduce the number of retransmissions of the preamble, a mechanism is required to increase the transmission power when changing the transmission beam.

In addition, when the transmission beam is changed without changing the transmission power in a state in which the transmission power of the preamble has become large to a certain extent (for example, in a state in which the transmission power of the preamble reaches a maximum transmission power or a specified transmission power), interference may become large depending on the characteristics or the like of the transmission beam. In order to reduce the interference, a mechanism is required to reduce the transmission power when changing the transmission beam. Alternatively, in order to reduce the interference, a mechanism is required to restrict the retransmission of the preamble when the beam switching is performed.

One object of the present invention is to realize a random access using an appropriate transmission power, by changing the transmission power when changing the transmission beam and retransmitting the preamble, or restricting the retransmission of the preamble when performing the beam switching.

### Means of Solving the Problem

In one embodiment of the present invention, there is provided a user equipment, including:

a random access control unit for deciding whether a condition that same transmission power is usable when changing a transmission beam and retransmitting a preamble is satisfied, and determining transmission power of the preamble based on the deciding; and

a transmission unit for transmitting the preamble using the determined transmission power.

### Effects of the Invention

According to the present invention, it is possible to realize a random access using an appropriate transmission power, by changing the transmission power when changing the transmission beam and retransmitting the preamble, or restricting the retransmission of the preamble when performing the beam switching.

### BRIEF DESCRIPTION OF THE DRAWING

FIG. 1 is a diagram of a configuration of a wireless communication system in one embodiment of the present invention.

FIG. 2 is a sequence diagram illustrating a random access procedure of the wireless communication system in one embodiment of the present invention.

FIG. 3 is a flow chart illustrating a random access control method of a user equipment in one embodiment of the present invention.

FIG. 4 is a diagram illustrating an example in which transmission power is increased when changing a transmission beam in the case where a number of times a preamble is transmitted using the same transmission power exceeds a specified number of times.

FIG. 5 is a diagram illustrating an example in which the transmission power is increased when changing the transmission beam in the case where a number of retransmissions of the preamble during the random access procedure exceeds a specified number of times.

FIG. 6 is a diagram illustrating an example in which the transmission power is decreased when changing the transmission beam in the case where the transmission power of the preamble reaches a maximum transmission power.

FIG. 7 is a diagram illustrating an example in which the transmission power is decreased when changing the transmission beam in the case where the transmission power of the preamble reaches a specified transmission power.

FIG. 8 is a diagram illustrating an example in which a number of times the transmission is possible using the maximum transmission power is restricted.

FIG. 9 is a diagram illustrating an example in which, in the example illustrated in FIG. 6, the number of times the transmission is possible using the maximum transmission power is restricted.

FIG. 10 is a block diagram illustrating an example of a functional structure of a base station.

FIG. 11 is a block diagram illustrating an example of a functional structure of a user equipment.

FIG. 12 is a diagram illustrating an example of a hardware structure of a wireless communication device in one embodiment of the present invention.

### MODE OF CARRYING OUT THE INVENTION

A description will hereinafter be given of one embodiment of the present invention by referring to the drawings. The embodiment described in the following is merely an example, and embodiments to which the present invention may be applied are not limited to the following embodiment.

In this embodiment, a description is given using the terminologies defined in LTE, where appropriate. In addition, the existing technologies defined in LTE may be used when a wireless communication system operates, where appropriate. However, the existing technologies are not limited to LTE. Further, unless otherwise indicated, “LTE” used in this specification is used in a broad sense including LTE-Advanced, and systems subsequent to LTE-Advanced. Moreover, the present invention is applicable to systems other than LTE, to which a random access is applicable.

For the sake of convenience, this embodiment uses terminologies such as RACH, preamble, beam forming, power ramping, beam switching, or the like used in the existing LTE, however, signals, functions, or the like similar to these may be referred to by other names.

### Summary of Wireless Communication System

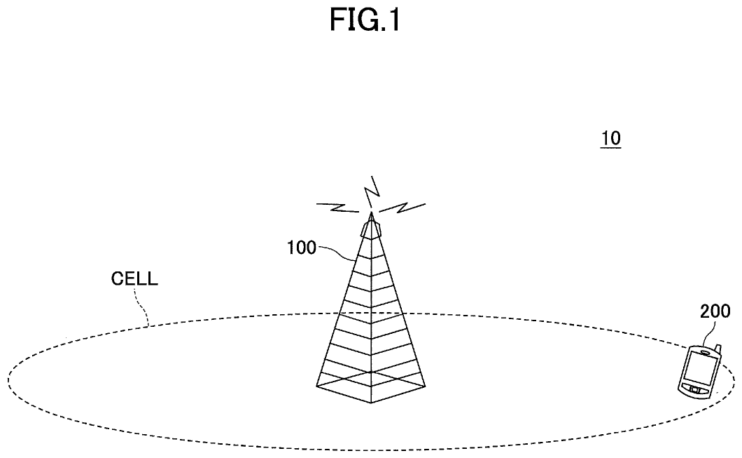

FIG. 1 is a diagram of a configuration of a wireless communication system 10 in one embodiment of the present invention. As illustrated in FIG. 1, the wireless communication system 10 in this embodiment includes a base station 100 and a user equipment 200. In the example illustrated in FIG. 1, one base station 100 and one user equipment 200 are illustrated, however, a plurality of base stations 100 may be provided, and a plurality of user equipments 200 may be provided. The base station 100 may be referred to as BS, and the user equipment 200 may be referred to as UE.

The base station 100 can accommodate one or a plurality of (for example, three) cells (also referred to as sectors). In the case where the base station 100 accommodates the plurality of cells, an overall coverage area of the base station 100 may be segmented into a plurality of smaller areas, and each of the smaller areas can provide a communication service by a base station subsystem (for example, indoor small base station RRH: Remote Radio Head). The terminology “cell” or “sector” indicates a part of or the entire coverage area of the base station and/or the base station subsystem providing the communication service in this coverage area. Further, the terminologies “base station”, “eNB”, “cell”, and “sector” are interchangeably used in this specification. The base station 100 may be referred to by terminologies such as as a fixed station, NodeB, eNodeB (eNB), access point, femtocell, small cell, or the like.

The user equipment 200 may be referred to by other appropriate terminologies such as a mobile station, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client, or the like.

In the case where the user equipment 200 establishes a connection or resynchronizes with the base station 100 for making an outgoing call, handover, or the like, a random access is performed.

In the random access, a channel for initially transmitting the preamble is referred to as a PRACH (Physical Random Access Chanel). In this embodiment, it is assumed that a transmission beam forming is applicable to the random access. The transmission beam forming is a technology that transmits a highly directional transmission beam to an opposite party, in order to improve radio field intensity.

When the user equipment 200, after transmitting the preamble, does not receive response information RAR within a period called a RAR window, for example, the user equipment 200 retransmits the preamble. As preamble retransmission schemes to which the transmission beam forming is applicable, this embodiment assumes the following two systems.

(1) Power Ramping: Transmission power at the time of the retransmission is made larger than that of a previous transmission. In this embodiment, it is assumed that the power ramping is used together with the beam switching. Hence, the power ramping includes using the same transmission beam and making the transmission power at the time of the retransmission larger than that of the previous transmission, and making the transmission power at the time of the retransmission larger than that of the previous transmission without depending on the transmission beam. An amount of increase of the transmission power according to the power ramping is referred to as a power ramping step or a power ramping step size.

(2) Beam Switching: At the time of the retransmission, a transmission beam different from that of the previous transmission, is applied. In the case where a plurality of transmission beams can be used for one transmission, the beam switching includes applying, at the time of the retransmission, a group of transmission beams different from a group of transmission beams used at the time of the previous transmission.

In addition, in order to manage a number of retransmissions in the user equipment 200, the following three counters are defined for the sake of convenience.

(1) Transmission Counter: A counter that manages a number of times the preamble is transmitted in a random access procedure. A counter value of the transmission counter is increased every time the preamble is transmitted.

(2) Power Ramping Counter: A counter that manages a number of times the power ramping is performed. A counter value of the power ramping counter is increased every time the power ramping is performed. The counter value is increased when the power ramping is performed at the time of the beam switching, however, the counter value does not change when the power ramping is not performed at the time of the beam switching and the transmission power does not change. In this embodiment, as will be described hereinafter, it is assumed that the transmission power is decreased at the time of the beam switching, and the counter value may be decreased in this case.

(3) Beam Switching Counter: A counter that manages a number of times the beam switching is performed. A counter value is increased every time the beam switching is performed. The counter value may or may not be reset, when the power ramping is performed.

Names of the counters described above merely are examples. The counters may have any name provided that the number of times described above can be managed. For example, the power ramping counter may be defined as a transmission counter.

In this embodiment, a description will be given of a mechanism to increase or decrease the transmission power when changing the transmission beam. In addition, a description will be given of a mechanism to restrict retransmission of the preamble when the beam switching is performed.

### Random Access Procedure in Wireless Communication System

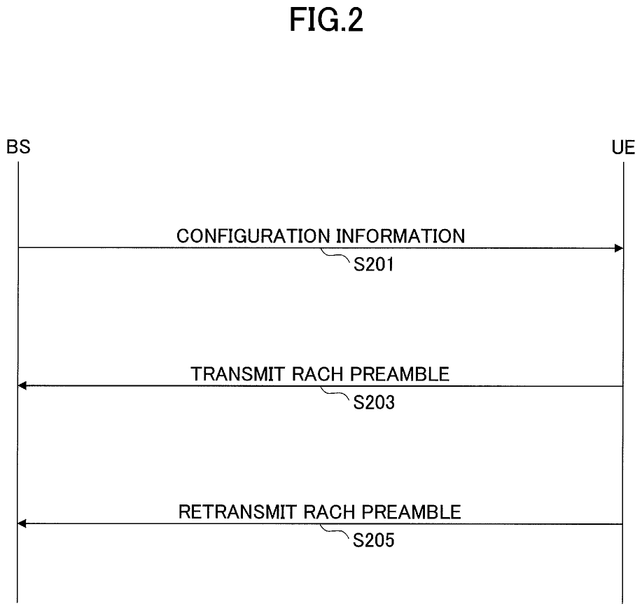

Next, a detailed description will be given of the random access procedure and a method of determining the transmission power of the preamble in the wireless communication system of this embodiment. FIG. 2 is a sequence diagram illustrating the random access procedure of the wireless communication system in this embodiment of the present invention.

The base station 100 generates and transmits configuration information to be referred to when the user equipment 200 retransmits the preamble in the random access (S201). In this embodiment, in order to realize the mechanism to increase or decrease the transmission power when changing the transmission beam, the configuration information may include a condition that the same transmission power can be used when changing the transmission beam and retransmitting the preamble. In addition, the configuration information may include a maximum number of retransmissions, an increased or decreased amount of transmission power at the time of the retransmission (including the power ramping step), or the like, and may include any one of configuration values used in this embodiment.

For example, this condition includes a condition that a number of times the preamble is transmitted using the same transmission power is less than or equal to a specified number of times, or a condition that the number of times the preamble is transmitted during the random access procedure is less than or equal to a specified number of times, or the like. In the case where this condition is not satisfied, such as a case where the number of times the user equipment 200 transmitted the preamble using the same transmission power exceeds the specified number of times, or a case where the number of times the preamble is transmitted during the random access procedure exceeds the specified number of times, for example, the user equipment 200 cannot use the same transmission power when changing the transmission beam and transmitting the preamble, and a different transmission power needs to be used. The base station 100 may provide a flag indicating whether to apply the condition, the specified number of times used in the condition, a power value to set the different transmission power, or the like as the configuration information.

In addition, this condition may include, for example, a condition that the transmission power of the preamble is less than a maximum transmission power, or a condition that the transmission power of the preamble is less than a specified transmission power, or the like. In the case where this condition is not satisfied, such as a case where the transmission power of the preamble reaches the maximum transmission power or the specified transmission power, for example, the user equipment 200 cannot use the same transmission power when changing the transmission beam and transmitting the preamble, and the different transmission power needs to be used. The base station 100 may provide the flag indicating whether to apply the condition, the power value to set the different transmission power, or the like as the configuration information.

The configuration information may be transmitted from the base station 100 to the user equipment 200 by broadcast information, RRC (Radio Resource Control) signaling, or the like. In addition, the configuration information may be transmitted from the base station 100 to the user equipment 200 by a combination of the broadcast information, the RRC signaling, or the like. When the combination is used, the user equipment 200 may use the configuration information according to a predetermined priority. For example, in the case where the configuration information is provided by the RRC signaling after the configuration information is provided by the broadcast information, the priority may be placed on the RRC signaling, and the configuration information provided by the broadcast information may be discarded. This example of the priority is merely an example, and any type of priority may be used.

All of or a part of the configuration information described above may be prescribed in advance according to specifications. In the case where the configuration information is prescribed in advance according to specifications, transmitting the configuration information from the base station 100 to the user equipment 200 (S201) may be omitted.

The user equipment 200 receives the configuration information from the base station 100, and transmits the preamble (S203). The user equipment 200 determines the transmission power of the preamble according to the configuration information when retransmitting the preamble, and transmits the preamble (S205). The user equipment 200 may decide, when retransmitting the preamble, whether to apply the power ramping or to apply the beam switching, according to a predetermined rule, or a communication environment, or the like. In the case where the user equipment 200 decides that the beam switching is to be applied, the user equipment 200 decides whether the condition that the same transmission power can be used is satisfied, and determines the transmission power of the preamble based on the decision. The user equipment 200 increases the transmission power of the preamble when the number of times the preamble is transmitted using the same transmission power exceeds the specified number of times, or the number of times the preamble is transmitted during the random access procedure exceeds the specified number of times, for example. The user equipment 200 decreases the transmission power of the preamble when the transmission power of the preamble reaches the maximum transmission power or the specified transmission power, for example.

In addition, when the number of times the preamble is retransmitted using the maximum transmission power is less than or equal to the specified number of times, the user equipment 200 may transmit the preamble. When the number of times the preamble is retransmitted using the maximum transmission power exceeds the specified number of times, the user equipment 200 may interrupt transmission of the preamble, or provide a notification to an upper layer but the random access procedure does not need to be discontinued.

Next, a detailed description will be given of illustrative embodiment 1 through illustrative embodiment 7 of the process of the user equipment 200 in step S205.

### Illustrative Embodiment 1

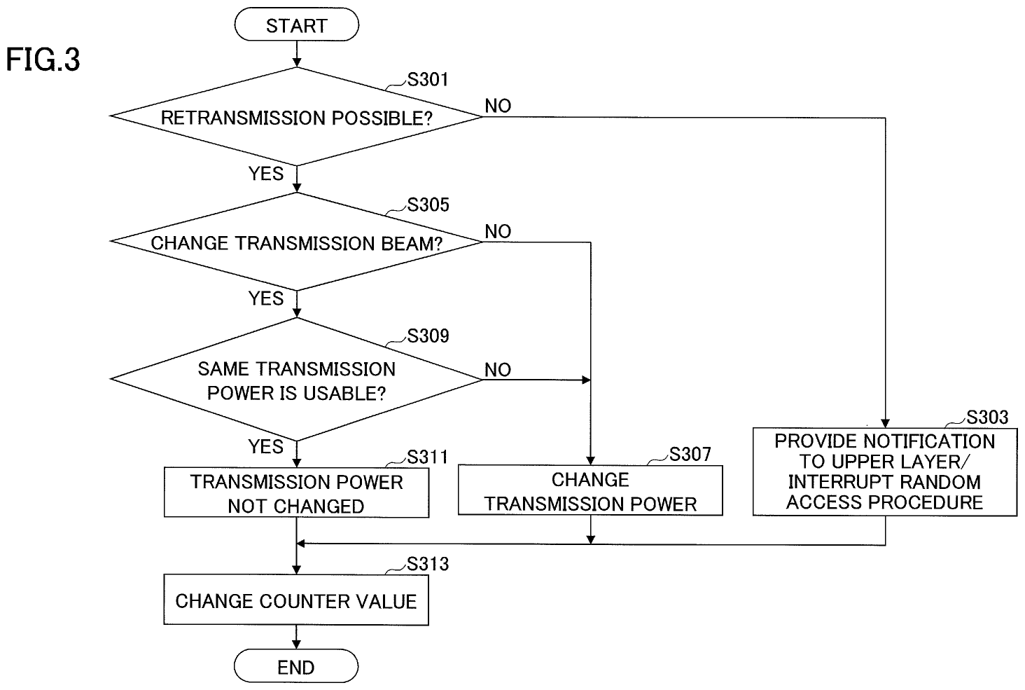

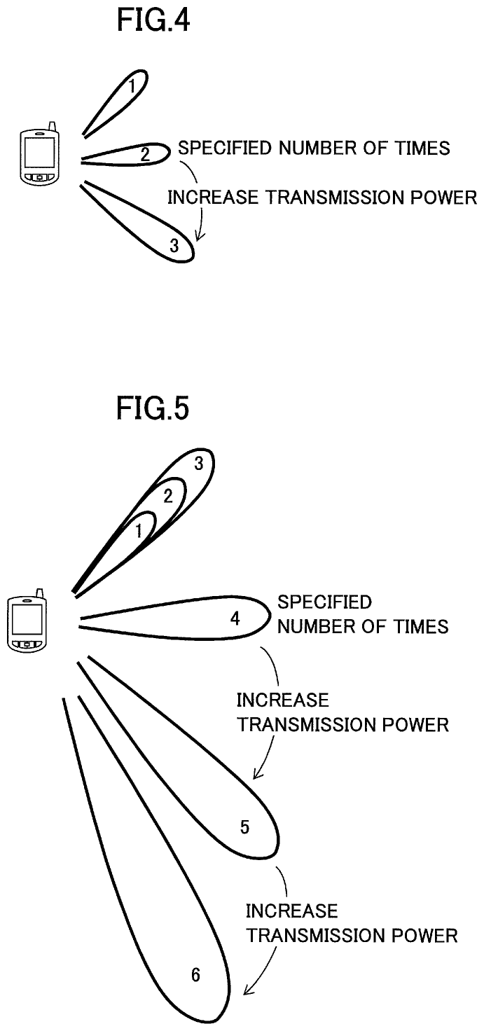

An illustrative embodiment in which the transmission power of the preamble is increased when applying the beam switching will be described, by referring to FIG. 3 and FIG. 4.

In the illustrative embodiment 1, it is assumed that, the condition that the same transmission power can be used when changing the transmission beam and retransmitting the preamble, includes the condition that the number of times the user equipment 200 transmits the preamble using the same transmission power is less than or equal to the specified number of times.

First, prior to retransmission of the preamble, the user equipment 200 decides whether the retransmission is possible (S301). For example, the user equipment 200 can recognize the number of retransmissions of the preamble by referring to the transmission counter. In the case where the number of retransmissions of the preamble is less than or equal to the maximum number of retransmissions, the user equipment 200 decides that the retransmission is possible. The user equipment 200 may decide that the retransmission is not possible in the case where the number of retransmissions of the preamble exceeds the maximum number of retransmission.

When the retransmission is not possible (S301: NO), the user equipment 200 may interrupt the random access procedure, or provide the notification to the upper layer but the random access procedure does not need to be interrupted (S303). For example, a random access problem may be provided to the upper layer, or the random access procedure may be interrupted in a physical layer, MAC (Medium Access Control) layer, RRC layer, or the like. Alternatively, interrupting of the random access procedure may be provided to the upper layer, or the random access procedure may be interrupted by initializing parameters or the like of the MAC layer by a MAC reset. The user equipment 200 resets the transmission counter, the power ramping counter, and the beam switching counter (S313). The user equipment 200 can resume the random access procedure by returning the transmission power to that at the time of an initial transmission, according to decisions in the upper layer, the physical layer, the MAC layer, the RRC layer, or the like.

When the retransmission is possible (S301: YES), the user equipment 200 decides whether to change the transmission beam, according to the predetermined rule, or the communication environment, or the like (S305). In the case where the transmission beam is not changed (S305: NO), the user equipment 200 increases the transmission power by the power ramping (S307). However, because the transmission power cannot be increased after the maximum transmission power is reached, the user equipment 200 may not change the transmission power, or may decrease the transmission power. Then, the user equipment 200 increases the transmission counter and the power ramping counter (S313). The power ramping counter is not changed when the transmission power is not changed, and the power ramping counter is decreased when the transmission power is decreased. The user equipment 200 may or may not reset the beam switching counter.

In the case where the transmission beam is changed (S305: YES), the user equipment 200 decides whether the same transmission power is usable (S309). For example, the user equipment 200 can recognize the number of times the preamble is transmitted using the same transmission power, by referring to the beam switching counter. When the number of times the preamble is transmitted using the same transmission power is less than or equal to the specified number of times (S309: YES), the user equipment 200 does not need to change the transmission power when changing the transmission beam (S311). The user equipment 200 increases the transmission counter and the beam switching counter (S313).

When the number of times the preamble is transmitted using the same transmission power exceeds the specified number of times (S309: NO), the user equipment 200 increases the transmission power of the preamble (S307). Then, the user equipment 200 increases the transmission counter and the power ramping counter (S313). The user equipment 200 may or may not reset the beam switching counter.

For example, in the case where the number of times the preamble can be transmitted using the same transmission power is two times, the user equipment 200 applies the beam switching up to the second transmission to transmit the preamble using the same transmission power, as illustrated in FIG. 4. However, for the third transmission, the user equipment 200 may apply the beam switching, but increases the transmission power.

The condition that the number of times the preamble is transmitted using the same transmission power is less than or equal to the specified number of times, may be replaced by a condition that the number of times the preamble is retransmitted using the same transmission power is less than or equal to the specified number of times. For example, in the case where the number of times the preamble can be retransmitted using the same transmission power is once, the user equipment 200 applies the beam switching up to the first retransmission (second transmission) to transmit the preamble using the same transmission power, as illustrated in FIG. 4. However, for the second retransmission (third transmission), the user equipment 200 may apply the beam switching, but increases the transmission power.

The same value used in the power ramping step, or a different value from that of the power ramping step, may be used as the amount of transmission power that is increased when the specified number is exceeded. In the case where the different value from that of the power ramping step is used, it is possible to use a difference value relative to the value used in the power ramping step, or to use the amount of increase of the power ramping counter. The amount of transmission power that is increased when the specified number is exceeded may be provided from the base station 100 as the configuration information, or may be prescribed in advance according to specifications.

### Illustrative Embodiment 2

An illustrative embodiment in which the transmission power of the preamble is increased when applying the beam switching will be described, by referring to FIG. 3 and FIG. 5.

In an illustrative embodiment 2, it is assumed that, the condition that the same transmission power can be used when changing the transmission beam and retransmitting the preamble, includes the condition that the number of times the user equipment 200 transmits the preamble during the random access procedure is less than or equal to the specified number of times.

Processes of steps S301 through S305 are the same as those of the illustrative embodiment 1, and thus, processes different from those of the illustrative embodiment 1 will be described in the following.

In the case in which the transmission beam is changed (S305: YES), the user equipment 200 decides whether the same transmission power is usable (S309). For example, the user equipment 200 can recognize the number of times the preamble is transmitted from the initial transmission, by referring to the beam switching counter. When the number of times the preamble is transmitted is less than or equal to the specified number of times (S309: YES), the user equipment 200 does not need to change the transmission power when changing the transmission beam (S311). The user equipment 200 increases the transmission counter and the beam switching counter (S313).

When the number of times the preamble is transmitted from the initial transmission exceeds the specified number of times (S309: NO), the user equipment 200 increases the transmission power of the preamble (S307). Then, the user equipment 200 increases the transmission counter and the power ramping counter (S313). The user equipment 200 may or may not reset the beam switching counter.

For example, in the case where the specified number of times the preamble can be transmitted without necessarily changing the transmission power is four times, the user equipment 200 can apply the power ramping or the beam switching up to the fourth transmission to transmit the preamble, as illustrated in FIG. 5. When applying the beam switching at the time of the fourth transmission, there is no need to change the transmission power. However, when making the fifth transmission, the user equipment 200 may apply the beam switching, but increases the transmission power. Accordingly, even when the transmission power is increased before reaching the specified number of times, the user equipment 200 increases the transmission power when the specified number of times is exceeded. When making the sixth and subsequent transmissions, the user equipment 200 may apply the beam switching, but may continue to increase the transmission power.

The condition that the number of times the preamble is transmitted during the random access procedure is less than or equal to the specified number of times, may be replaced by a condition that the number of times the preamble is retransmitted during the random access procedure is less than or equal to the specified number of times. For example, in the case where the number of times the preamble can be retransmitted without necessarily changing the transmission power is three times, the user equipment 200 does not need to change the transmission power when applying the beam switching to the third retransmission (fourth transmission), as illustrated in FIG. 5. However, for the fourth retransmission (fifth transmission), the user equipment 200 may apply the beam switching, but increases the transmission power.

The same value used in the power ramping step, or a different value from that of the power ramping step, may be used as the amount of transmission power that is increased when the specified number is exceeded. In the case in which the different value from that of the power ramping step is used, it is possible to use the difference value relative to the value used in the power ramping step, or to use the amount of increase of the power ramping counter. The amount of transmission power that is increased when the specified number is exceeded may be provided from the base station 100 as the configuration information, or may be prescribed in advance according to specifications.

The illustrative embodiment 2 may be used in combination with the illustrative embodiment 1.

### Illustrative Embodiment 3

Next, an illustrative embodiment in which the retransmission of the preamble is restricted after the specified number of times described above is exceeded, when the illustrative embodiment 1 or the illustrative embodiment 2 is used, will be described.

First, prior to retransmission of the preamble, the user equipment 200 decides whether the retransmission is possible (S301). In an illustrative embodiment 3, the retransmission of the preamble is restricted according to the number of retransmissions of the preamble after the specified number of times is exceeded. For example, the user equipment 200 can recognize the number of retransmissions of the preamble after the specified number of times is exceeded, by referring to the amount of increase of the transmission counter after the specified number of times is exceeded. In addition, in the case where the user equipment 200 performs the beam switching after the specified number of times is exceeded, for example, the user equipment 200 can recognize the number of retransmissions of the preamble after the specified number of times is exceeded, by referring to the beam switching counter. The user equipment 200 can retransmit the preamble until the number of retransmissions after the specified number of times is exceeded reaches a specified number of retransmissions. The user equipment 200 may decide that the retransmission is not possible in the case where the number of retransmissions of the preamble after the specified number of times is exceeded reaches the specified number of retransmissions.

When the retransmission is not possible (S301: NO), the user equipment 200 may interrupt the random access procedure, or provide the notification to the upper layer but the random access procedure does not need to be interrupted (S303). Interrupting the random access procedure/providing the notification to the upper layer, and subsequent processes may be realized similarly to the illustrative embodiment 1.

The specified number of retransmissions, which is an upper limit value of the number of retransmissions of the preamble that can be retransmitted after the specified number of times is exceeded, may be provided from the base station 100 as the configuration information, or may be prescribed in advance according to specifications. In addition, a maximum value with which the beam switching counter may be increased, or a maximum value by which the transmission counter may be increased after the specified number of times is exceeded, after a maximum value of the beam switching counter or a maximum value of the transmission counter or the specified number of times is exceeded, may be specified as the specified number of retransmissions.

For example, in the example of FIG. 5, in the case where the maximum value of the beam switching counter is three times, or the maximum value of the transmission counter is six times, or the maximum value with which the beam switching counter may be increased after the specified number of times is exceeded is two times, or the maximum value with which the transmission counter may be increased after the specified number of times is exceeded is two times, the user equipment 200 may decide that the seventh transmission of the preamble is not possible.

### Illustrative Embodiment 4

Next, an illustrative embodiment in which the retransmission of the preamble is restricted after the specified number of times described above is exceeded, when the illustrative embodiment 1 or the illustrative embodiment 2 is used, will be described.

First, prior to retransmission of the preamble, the user equipment 200 decides whether the retransmission is possible (S301). In an illustrative embodiment 4, the retransmission of the preamble is restricted according to the transmission power of the preamble after the specified number of times is exceeded. In the case where the transmission power of the preamble is increased by the power ramping or the like after the specified number of times is exceeded, the user equipment 200 can retransmit the preamble until the transmission power of the preamble exceeds a specified transmission power. The user equipment 200 may decide that the retransmission is not possible in the case where the transmission power of the preamble exceeds the specified transmission power by the power ramping or the like after the specified number of times is exceeded. The specified transmission power may be a maximum transmission power of the user equipment 200.

When the retransmission is not possible (S301: NO), the user equipment 200 may interrupt the random access procedure, or provide the notification to the upper layer but the random access procedure does not need to be interrupted (S303). Interrupting the random access procedure/providing the notification to the upper layer, and subsequent processes may be realized similarly to the illustrative embodiment 1.

The specified transmission power, which is an upper limit value of the the transmission power at which the preamble may be transmitted after after the specified number of times is exceeded, may be provided from the base station 100 as the configuration information, or may be prescribed in advance according to specifications. In addition, an absolute value of the transmission power, or a relative value with respect to the transmission power of the initial transmission, or a tolerable number of times the power ramping may be applied, may be specified as the specified transmission power. Alternatively, the maximum value of the power ramping counter, or the maximum value with which the power ramping counter may be increased after the specified number of times is exceeded, may be specified as the specified transmission power.

For example, in the example of FIG. 5, in the case where the maximum value of the beam switching counter is four times, or the maximum value of the with which the power ramping counter may be increased after the specified number of times is exceeded is two times, the user equipment 200 may decide that the seventh transmission of the preamble is not possible.

The illustrative embodiment 4 may be used in combination with the illustrative embodiment 3.

### Illustrative Embodiment 5

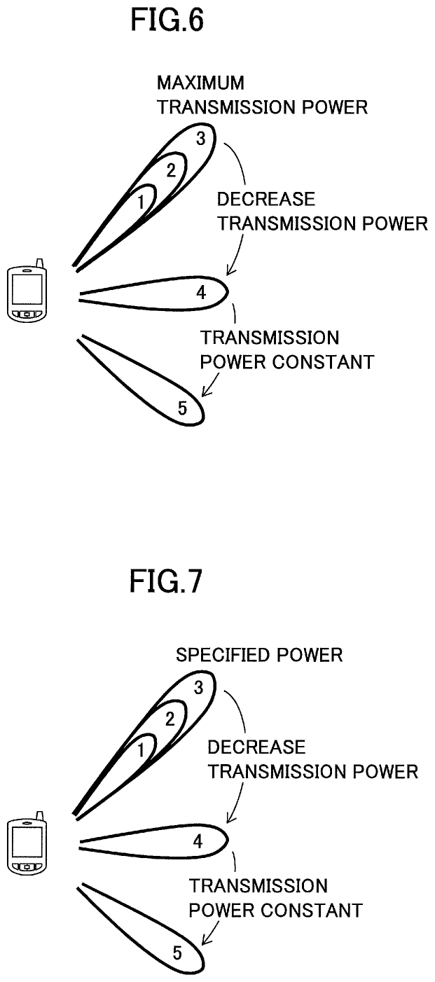

An illustrative embodiment in which the transmission power of the preamble is decreased when applying the beam switching, will be described by referring to FIG. 3 and FIG. 6.

In an illustrative embodiment 5, it is assumed that, the condition that the same transmission power can be used when changing the transmission beam and retransmitting the preamble, includes the condition that the transmission power of the preamble of the user equipment 200 is less than the maximum transmission power.

Processes of steps S301 through S305 are the same as those of the illustrative embodiment 1, and thus, processes different from those of the illustrative embodiment 1 will be described in the following.

In the case in which the transmission beam is changed (S305: YES), the user equipment 200 decides whether the same transmission power is usable (S309). When the transmission power of the preamble is less than the maximum transmission power (S309: YES), the user equipment 200 does not need to change the transmission power when changing the transmission beam (S311). The user equipment 200 increases the transmission counter and the beam switching counter (S313).

When the transmission power of the preamble reaches the maximum transmission power (S309: NO), the user equipment 200 decreases the transmission power of the preamble (S307). The maximum transmission power may be made to correspond to the power ramping counter. For example, when the power ramping counter reaches the maximum value at the time of the retransmission immediately after the user equipment 200 changes the transmission beam, the power ramping counter may be changed to the value X that is less than the maximum value of the power ramping counter, and the preamble may be transmitted at the transmission power corresponding to the value X. Then, the user equipment 200 increases the transmission counter and decreases the power ramping counter (S313). The user equipment 200 may or may not reset the beam switching counter.

For example, in the case where the maximum transmission power is reached at the third transmission, the user equipment 200 may apply the beam switching for the fourth transmission, but decreases the transmission power. For the fifth and subsequent transmissions, the user equipment 200 may not change the transmission power, or increase the transmission power by the power ramping, or further decrease the transmission power.

The maximum transmission power may be a maximum transmission power with which the terminal can transmit, and may be provided from the base station 100 as the configuration information, or prescribed in advance according to specifications. In addition, the absolute value of the transmission power, or the relative value with respect to the transmission power of the initial transmission, or the tolerable number of times the power ramping may be applied, may be specified as the maximum transmission power.

In addition, the same value used in the power ramping step, or a different value from that of the power ramping step, may be used as the amount of transmission power that is decreased when the maximum transmission power is reached. In the case where the different value from that of the power ramping step is used, it is possible to use a difference value relative to the value used in the power ramping step, or to use the amount of decrease of the power ramping counter. The amount of transmission power that is decreased when the maximum transmission power is reached may be provided from the base station 100 as the configuration information, or may be prescribed in advance according to specifications.

After the maximum transmission power is reached, the preamble may be retransmitted without changing the transmission beam. In this case, the user equipment 200 may retransmit the preamble by maintaining the maximum transmission power without changing the transmission power, or by decreasing the transmission power. In the case where the transmission power is not changed, the user equipment 200 increases the transmission counter. In the case where the transmission power is decreased, the user equipment 200 increases the transmission counter, and decreases the power ramping counter, similarly to step 5313. Further, the beam switching counter may or may not be reset.

The illustrative embodiment 5 may be used in combination with any of the illustrative embodiments 1 through 4.

### Illustrative Embodiment 6

An illustrative embodiment in which the transmission power of the preamble is decreased when applying the beam switching, will be described by referring to FIG. 3 and FIG. 7.

In an illustrative embodiment 6, it is assumed that, the condition that the same transmission power can be used when changing the transmission beam and retransmitting the preamble, includes the condition that the transmission power of the preamble of the user equipment 200 is less than the specified transmission power.

Processes of steps S301 through S305 are the same as those of the illustrative embodiment 1, and thus, processes different from those of the illustrative embodiment 1 will be described in the following.

In the case in which the transmission beam is changed (S305: YES), the user equipment 200 decides whether the same transmission power is usable (S309). When the transmission power of the preamble is less than the specified transmission power (S309: YES), the user equipment 200 does not need to change the transmission power when changing the transmission beam (S311). The user equipment 200 increases the transmission counter and the beam switching counter (S313).

When the transmission power of the preamble reaches the specified transmission power (S309: NO), the user equipment 200 decreases the transmission power of the preamble (S307). The specified transmission power may be made to correspond to the power ramping counter. For example, when the power ramping counter is greater than the value X at the time of the retransmission immediately after the user equipment 200 changes the transmission beam, the power ramping counter may be changed to the value X, and the preamble may be transmitted at the transmission power corresponding to the value X. Then, the user equipment 200 increases the transmission counter and decreases the power ramping counter (S313). The user equipment 200 may or may not reset the beam switching counter.

For example, in the case where the specified transmission power is reached at the third transmission, the user equipment 200 may apply the beam switching for the fourth transmission, but decreases the transmission power. For the fifth and subsequent transmissions, the user equipment 200 may not change the transmission power, or increase the transmission power by the power ramping, or further decrease the transmission power.

The specified transmission power may be provided from the base station 100 as the configuration information, or may be prescribed in advance according to specifications. In addition, an absolute value of the transmission power, or a relative value with respect to the transmission power of the initial transmission, or a tolerable number of times the power ramping may be applied, may be specified as the specified transmission power.

The same value used in the power ramping step, or a different value from that of the power ramping step, may be used as the amount of transmission power that is decreased when the maximum transmission power is reached. In the case where the different value from that of the power ramping step is used, it is possible to use a difference value relative to the value used in the power ramping step, or to use the amount of decrease of the power ramping counter. The amount of transmission power that is decreased when the maximum transmission power is reached may be provided from the base station 100 as the configuration information, or may be prescribed in advance according to specifications.

The illustrative embodiment 6 may be used in combination with any of the illustrative embodiments 1 through 5.

### Illustrative Embodiment 7

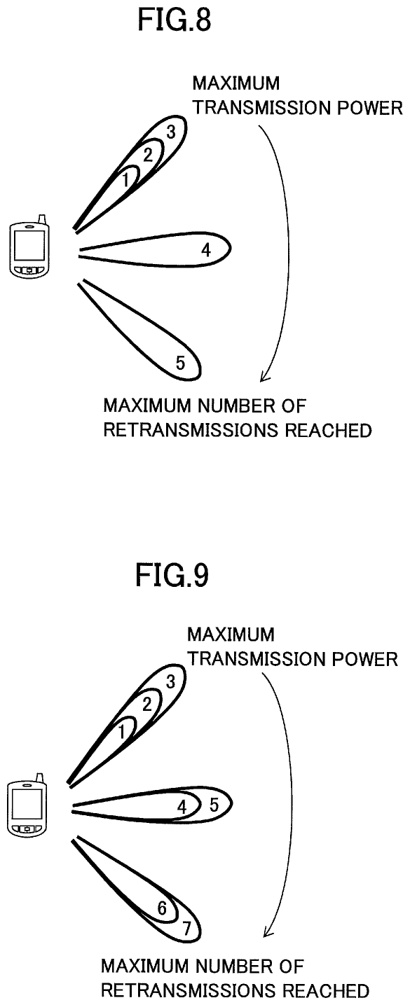

An illustrative embodiment in which the number of retransmissions of the preamble, possible using the maximum transmission power, is restricted, will be described by referring to FIG. 3, FIG. 8, and FIG. 9.

First, prior to retransmission of the preamble, the user equipment 200 decides whether the retransmission is possible (S301). In an illustrative embodiment 7, the retransmission of the preamble is restricted according to the number of retransmissions of the preamble using the maximum transmission power during the random access procedure. A specified number of retransmissions of the preamble, possible using the maximum transmission power during the random access procedure, may be provided from the base station 100 as the configuration information, or may be prescribed in advance according to specifications. The specified number of retransmissions of the preamble, possible using the maximum transmission power during the random access procedure, may be replaced by a number of times the preamble can be transmitted after the power ramping counter becomes the maximum value. When retransmitting the preamble, the user equipment 200 decides whether the number of retransmissions of the preamble using the maximum transmission power is less than or equal to the specified number of retransmissions of the preamble. In the case where the number of retransmissions of the preamble using the maximum transmission power is less than or equal to the specified number of retransmissions of the preamble, the user equipment 200 decides that the retransmission is possible. In the case where the number of retransmissions of the preamble using the maximum transmission power exceeds the specified number of retransmissions of the preamble, the user equipment 200 may decide that the retransmission is not possible.

For example, in the case where the specified number of retransmissions of the preamble, possible using the maximum transmission power, is three times, the user equipment 200 can make the transmission up to the fifth transmission when the maximum transmission power is reached at the third transmission, but may decide that the sixth transmission is not possible, as illustrated in FIG. 8

When the retransmission is not possible (S301: NO), the user equipment 200 may interrupt the random access procedure, or provide the notification to the upper layer but the random access procedure does not need to be interrupted (S303). Interrupting the random access procedure/providing the notification to the upper layer, and subsequent processes may be realized similarly to the illustrative embodiment 1.

In the case in which the retransmission is possible (S301: YES), the transmission power cannot be increased (S309: YES) when the user equipment 200 changes the transmission beam (S305: YES), and the preamble is transmitted by maintaining the maximum transmission power (S311). The user equipment 200 increases the transmission counter and the beam switching counter (S313). Alternatively, as described in conjunction with the illustrative embodiment 5, in the case in which the retransmission is possible (S301: YES), because the transmission power of the preamble is the maximum transmission power (S309: NO) when the user equipment 200 changes the transmission beam (S305: YES), the user equipment 200 decreases the transmission power of the preamble (S307). The user equipment 200 increases the transmission counter, and decreases the power ramping counter (S313). The user equipment 200 may or may not reset the beam switching counter.

The illustrative embodiment 7 may be used in combination with any of the illustrative embodiments 1 through 6. For example, an example that combines the illustrative embodiment 7 and the illustrative embodiment 5 is illustrated in FIG. 9. In the case where the specified number of retransmissions of the preamble, possible using the maximum transmission power, is three times, the user equipment 200, even when the maximum transmission power is reached at the third transmission, decreases the transmission power at the fourth transmission and the sixth transmission, and decides that the transmission is possible up to the seventh transmission, as illustrated in FIG. 9.

### Functional Structure of Base Station

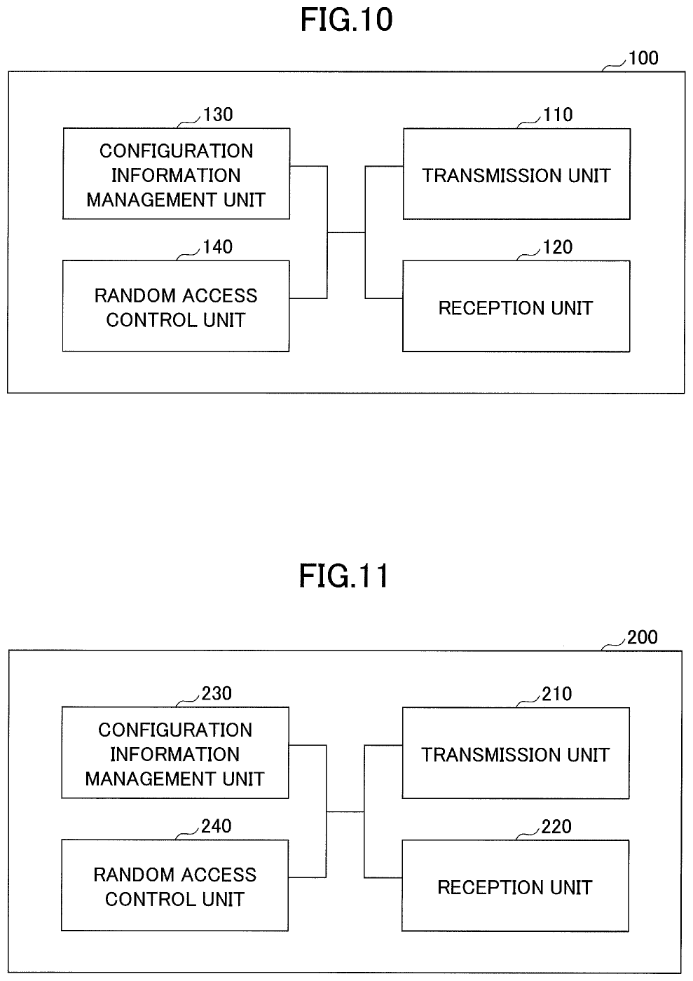

FIG. 10 is a block diagram illustrating an example of a functional structure of the base station 100. The base station 100 has a transmission unit 110, a reception unit 120, a configuration information management unit 130, and a random access control unit 140. The functional structure illustrated in FIG. 10 is merely an example, and functional classifications and functional units may have any name provided that the operation of this embodiment can be executed.

The transmission unit 110 is configured to generate signals of the lower layers from information of the upper layers, and to transmit the signals by wireless transmission. The reception unit 120 is configured to receive various signals by wireless reception, and to acquire the information of the upper layers from the received signals.

The configuration information management unit 130 stores the preset configuration information. In addition, the configuration information management unit 130 determines and holds the configuration information (the condition that the same transmission power is usable when changing the transmission beam and retransmitting the preamble, the maximum number of retransmissions, the amount of increase or decrease of the transmission power at the time of the retransmission, any of the configuration values used in this embodiment, or the like) to be set dynamically and/or semi-statically with respect to the user equipment 200. The configuration information management unit 130 transfers, to the transmission unit 110, the configuration information to be set dynamically and/or semi-statically with respect to the user equipment 200, and causes the transmission unit 110 to transmit the configuration information.

The random access control unit 140 manages the random access procedure with the user equipment 200. When the preamble is received from the user equipment 200, the random access control unit 140 causes the transmission unit 110 to transmit RAR. When RRC Connection Request is received from the user equipment 200, the random access control unit 140 causes the transmission unit 110 to transmit RRC Connection Setup.

### Functional Structure of User Apparatus

FIG. 11 is a block diagram illustrating an example of a functional structure of the user equipment 200. The user equipment 200 has a transmission unit 210, a reception unit 220, a configuration information management unit 230, and a random access control unit 240. The functional structure illustrated in FIG. 11 is merely an example, and functional classifications and functional units may have any name provided that the operation of this embodiment can be executed.

The transmission unit 210 is configured to generate signals of the lower layers from information of the upper layers, and to transmit the signals by wireless transmission. When retransmitting the preamble based on the configuration information stored in the configuration information management unit 230 which will be described later, the transmission unit 210 applies the beam switching and/or the power ramping and transmits the preamble. The reception unit 220 is configured to receive various signals by wireless reception, and to acquire the information of the upper layers from the received signals. The reception unit 220 receives the configuration information (the condition that the same transmission power is usable when changing the transmission beam and retransmitting the preamble, the maximum number of retransmissions, the amount of increase or decrease of the transmission power at the time of the retransmission, any of the configuration values used in this embodiment, or the like).

The configuration information management unit 230 stores the preset configuration information. In addition, the configuration information management unit 230 stores the configuration information (the condition that the same transmission power is usable when changing the transmission beam and retransmitting the preamble, the maximum number of retransmissions, the amount of increase or decrease of the transmission power at the time of the retransmission, any of the configuration values used in this embodiment, or the like) that is dynamically and/or semi-statically provided by the base station 100 or the like. The configuration information that can be managed in the configuration information management unit 230 is not limited to the configuration information provided by the base station 100 or the like, and also includes the configuration information prescribed in advance according to specifications.

The random access control unit 240 manages the random access procedure with the base station 100. In the case where the user equipment 200 establishes a connection or resynchronizes with the base station 100 for making an outgoing call, handover, or the like, the random access control unit 240 causes the transmission unit 210 to transmit the preamble selected at random from the plurality of preambles. In addition, when the random access control unit 240, after transmitting the preamble, does not receive the response information RAR within the period called the RAR window, for example, the random access control unit 240 causes the transmission unit 240 to retransmit the preamble. At the time of the retransmission, the random access control unit 240 determines the transmission power of the preamble as described with reference to FIG. 3 through FIG. 9, according to the configuration information managed in the configuration information management unit 230. In addition, the random access control unit 240 decides whether the retransmission of the preamble is possible as described with reference to FIG. 3 through 9, according to the configuration information managed in the configuration information management unit 230, and may interrupt the random access procedure if necessary, or provide the notification to the upper layer but the random access procedure does not need to be interrupted. When RAR is received from the base station 100, the random access control unit 240 causes the transmission unit 210 to transmit RRC Connection Request.

### Example of Hardware Structure

The block diagrams used to describe the above embodiments illustrate the blocks in functional units. These functional blocks (components) may be realize by arbitrary combinations of hardware and/or software. In addition, means for realizing each functional block is not limited to a particular means. In other words, each function block may be realized by a single device that is physically and/or logically integrated, or by a plurality of devices by connecting two or more physically and/or logically separated devices directly and/or indirectly (for example, by cable and/or wireless).

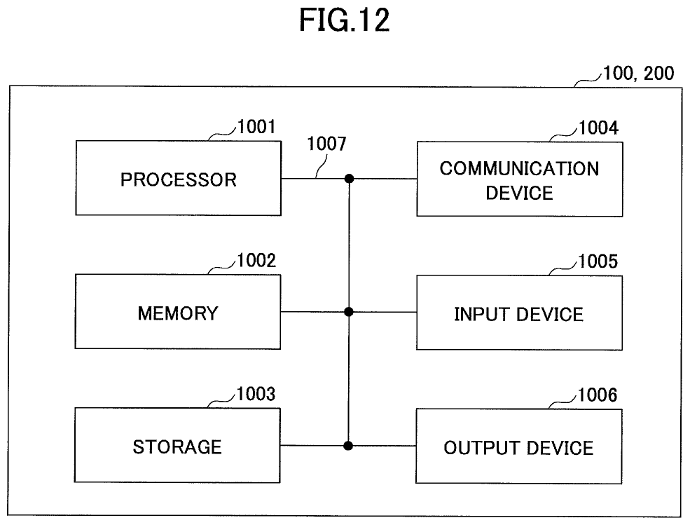

For example, the base station, the user equipment, or the like in one embodiment of the present invention may function as a computer that performs the process of the random access method according to the present invention. FIG. 12 is a diagram illustrating an example of a hardware structure of a wireless communication device, which is the base station 100 or the user equipment 200, in one embodiment of the present invention. The base station and the user equipment 200 may be formed as a computer physically including a processor 1001, a memory 1002, a storage 1003, a communication device 1004, an input device 1005, an output device 1006, a bus 1007, or the like.

In the following description, the terminology “apparatus” may be replaced by a circuit, a device, a unit, or the like. The hardware structure of the base station 100 and the user equipment 200 may be formed to include one or a plurality of each of the devices illustrated in FIG. 12, or may be formed not to include a part of the devices.

Each function of the base station 100 and the user equipment 200 may be realized by reading predetermined software (program) into the hardware such as the processor 1001 and the memory 1002, performing computations by the processor 1001, and controlling communication by the communication device 1004 and/or write and/or read of data to and/or from the memory 1002 and the storage 1003.

The processor 1001 controls the entire computer by operating an operating system, for example. The processor 1001 may be formed by a CPU (Central Processing Unit) including an interface with respect to a peripheral device, a control device, a computation device, a register, or the like. For example, the transmission unit 110, the reception unit 120, the configuration information management unit 130, and the random access control unit 140 of the base station 100, and the transmission unit 210, the reception unit 220, the configuration information management unit 230, and the random access control unit 240 of the user equipment 200, may be formed by the processor 1001.

In addition, the processor 1001 reads a program (program code), software module, and/or data from the storage 1003 and/or from the communication device 1004 to the memory 1002, and executes various processes according to the read program, software module, and/or data. The program uses a program for causing the computer to execute at least a part of the operation of the embodiments described above. For example, the transmission unit 110, the reception unit 120, the configuration information management unit 130, and the random access control unit 140 of the base station 100, and the transmission unit 210, the reception unit 220, the configuration information management unit 230, and the random access control unit 240 of the user equipment 200, may be realized by a control program that is stored in the memory 1002 and operates in the processor 1001. Other functional blocks may be realized in a similar manner. Each of the various processes described above are described as being executed by the single processor 1001, however, each of the various processes may be simultaneously or successively executed by two or more processors 1001. The processor 1001 may be implemented in one or more chips. The program may be transmitted from a network through telecommunication lines.

The memory 1002 is a computer-readable recording medium, and may be formed by at least one of a ROM (Read Only Memory), an EPROM (Erasable Programmable ROM), EEPROM (Electrically Erasable Programmable ROM), a RAM (Random Access Memory), or the like. The memory 1002 may be referred to as a register, a cache, a main memory (main storage device), or the like. The memory 1002 may store the program (program code), the software module, or the like that are executable to perform the random access method in one embodiment of the present invention.

The storage 1003 is a computer-readable recording medium, and may be formed by at least one of an optical disc such as a CD-ROM (Compact Disc ROM) or the like, a hard disc drive, a flexible disc, a magneto-optical disc (for example, a compact disc, a digital versatile disc, Blu-ray (registered trademark) disc), a smart card, a flash memory (for example, a card, a stick, and a key drive), a floppy (registered trademark) disc, a magnetic strip, or the like. The storage 1003 may be referred to as an auxiliary storage device. The recording medium described above may be a database, a server, and other appropriate media including the memory 1002 and/or the storage 1003.

The communication device 1004 is hardware (transmission and reception device) for performing communication between computers via the cable and/or wireless network. The communication device 1004 may be referred to as a network device, a network controller, a network card, a communication module, or the like. For example, the transmission unit 110, the reception unit 120, the transmission unit 210, the reception unit 220, or the like may be realized by the communication device 1004.

The input device 1005 is an input device (for example, a keyboard, a mouse, a microphone, a switch, a button, a sensor, or the like) that receives an external input. The output device 1006 is an output device (for example, a display, a speaker, a LED lamp, or the like) that makes an output to an outside. The input device 1005 and the output device may have an integral structure (for example, a touchscreen panel).

Each device such as the processor 1001 and/or the memory 1002 is connected to the bus 1007 to communicate information. The bus 1007 may be formed by a single bus, or by buses that are different among the devices.

The base station 100 and the user equipment 200 may be formed by hardware including a microprocessor, a DSP (Digital Signal Processor), an ASIC (Application Specific Integrated Circuit), a PLD (Programmable Logic Device), a FPGA (Field Programmable Gate Array), or the like. A part or all of the functional blocks may be realized by such hardware. For example, the processor 1001 may be implemented in at least one such hardware.

### Effect of Embodiment of Present Invention

According to one embodiment of the present invention, it is possible to realize a random access using an appropriate transmission power, by increasing or decreasing the transmission power when changing the transmission beam and retransmitting the preamble.

More particularly, by increasing the transmission power when changing the transmission beam and retransmitting the preamble, it is possible to reduce the number of retransmissions of the preamble in the environment in which the characteristic difference for each transmission beam is not large. In this case, by restricting the retransmission of the preamble after the specified number is exceeded, it is possible to avoid a situation in which the transmission power continues to be increased and the interference becomes large. In addition, when merely using the maximum number of retransmissions used in LTE, the retransmission may be restricted by the maximum number of retransmissions, even though there is room to change the transmission beam and increase the transmission power when combining the beam switching and the power ramping. On the other hand, by restricting the retransmission of the preamble after the specified number is exceeded, it is possible to appropriately restrict the retransmission when combining the beam switching and the power ramping.

In addition, by decreasing the transmission power when changing the transmission beam and retransmitting the preamble, it is possible to reduce the interference.

Further, the interference can also be reduced, by restricting the number of times the user equipment can retransmit the preamble using the maximum transmission power. In this case, when merely using the maximum number of retransmissions used in LTE, similarly as in the case described above, the transmission beam may continue to be switched using the maximum transmission power and the interference may become large, when combining the beam switching and the power ramping. On the other hand, by restricting the number of times the preamble can be retransmitting using the maximum transmission power, it is possible appropriately restrict the retransmission when combining the beam switching and the power ramping.

### Supplements

Each aspect/embodiment described in this specification may be applied to LTE (Long Term Evolution), LTE-A (LTE-Advanced), SUPER 3G, IMT-Advanced, 4G, 5G, FRA (Future Radio Access), W-CDMA (registered trademark), GSM (registered trademark), CDMA 2000, UMB (Ultra Mobile Broadband), IEEE 802.11

(Wi-Fi), IEEE 802.16 (WiMAX), IEEE 802.20, UWB (Ultra-WideBand), Bluetooth (registered trademark), a system utilizing other appropriate systems, and/or next-generation systems extended based on such systems.

The terminologies “system” and “network” used in this specification may be used interchangeably.

Specific operation described in this specification as being performed by the base station may in some cases be performed by an upper node. In a network formed by one or a plurality of network nodes having the base station, various operations that are performed for the communication with the terminal may of course be performed by the base station and/or another network node (for example, MME or S-GW or the like, but not limited to such) other than the base station. Although one network node other than the base station is described in the above example, a combination of a plurality of other network nodes (for example, MME and S-GW) may be used.

The information or the like may be output from the upper layer (or lower layer) to the lower layer (or upper layer). The information or the like may also be input and output via a plurality of network nodes.

The information or the like that is input and output may be stored at a specific location (for example, memory), and managed by a management table. The information or the like that is input and output may be overwritten, updated, or added. The information or the like that is output may be deleted. The information or the like that is input may be transmitted to other apparatuses.

Notifying the information is not limited to that of the aspect/embodiment described in this specification, and other methods may be employed. For example, providing the information may be performed by physical layer signaling (for example, DCI (Downlink Control Information), UCI (Uplink Control Information)), upper layer signaling (for example, RRC (radio Resource Control) signaling, MAC (Medium Access Control) signaling, broadcast information (MIB (Master Information Block), SIB (System Information Block))), other signals, or combinations thereof. In addition, the RRC signaling may be referred to as a RRC message, and may be a RRC Connection Setup message, a RRC Connection Reconfiguration message, or the like, for example.

The decision may be made according to a value represented by one bit (0 or 1), or a Boolean value (Boolean: true or false), or a comparison of numerical values (for example, comparison with a predetermined value).

Regardless of whether the software is called software, firmware, middleware, microcode, hardware description language, or by other names, the software is to be broadly interpreted to mean command, instruction set, code, code segment, program code, program, subprogram, software module, application, software application, software package, routine, subroutine, object, executable file, thread of execution, procedure, function, or the like.

In addition, the software, command, or the like may be transmitted and received via transmission media. For example, in the case where the software is transmitted from a website, server, or other remote resource using cable technology such as coaxial cable, optical fiber cable, twisted pair, and DSL (Digital Subscriber Line), and/or wireless technology such as infrared, radio, and microwave, such cable technology and/or wireless technology are included within the definition of the transmission media.

The information, signal, or the like described in this specification may be represented by any of various different technologies. For example, data, instruction, command, information, signal, bit, symbol, chip, or the like used throughout the description above may be presented by voltage, current, electromagnetic wave, magnetic field or magnetic particles, optical field or photons, or arbitrary combinations thereof.

The terminologies described in this specification and/or the terminologies required for understanding of this specification may be replaced with terminologies having the same or similar meanings. For example, a channel and/or a symbol may be a signal. In addition, the signal may be a message. Further, a CC (Component Carrier) may be called a carrier frequency, a cell, or the like.

The information, parameter, or the like described in this specification may be represented by an absolute value, or a relative value with respect to a predetermined value, or other corresponding information. For example, a wireless resource may be instructed by an index.

The names used for the parameters described above should not be narrowly interpreted at any point. Further, numerical formulas or the like using these parameters may be different from the numerical formulas explicitly disclosed in this specification. Various channels (for example, PUCCH, PDCCH, or the like) and information elements (for example, TPC or the like) may be identified by any suitable names, and the names assigned to the various channels and information elements should not be narrowly interpreted at any point.

The terminologies “determining (judging)” and “deciding (determining)” used in this specification may include various types of operations. For example, “determining” or “deciding” may include deeming that a result of calculating, computing, processing, deriving, investigating, looking up (for example, search in a table, a database, or other data structure), or ascertaining is “determined” or “decided”. In addition, “determining” or “deciding” may include deeming that a result of receiving (for example, receiving information), transmitting (for example, transmitting information), input, output, or accessing (for example, accessing data in a memory) is “determined” or “decided”. Furthermore, “determining” or “deciding” may include deeming that a result of resolving, selecting, choosing, establishing, or comparing is “determined” or “decided”. In other words, “determining” or “deciding” may include deeming that some type of operation is “determined” or “decided”.

The expression “based on” used in this specification does not mean “based solely on” unless otherwise indicated. In other words, the expression “based on” means both “based solely on” and “based at least on”.

Elements designated using names such as “first”, “second”, or the like in this specification not not imply amounts or priorities of these elements. Such names are used in this specification for the sake of convenience as a method of distinguishing two or more elements from each other. Accordingly, references to the first and second elements do not imply that only the two elements should be employed, nor that the first element should precede the second elements in any way.

The terminologies “include”, “including”, and variations thereof are intended to have an inclusive meaning, similar to the terminology “comprising”, when these terminologies are used in this specification and claims. Further, the terminology “or” used in this specification and claims is not intended to mean an exclusive logical sum.

The order of the processing procedure, sequence, flow chart, or the like of each example/embodiment described in this specification may be interchanged unless contradictory. For example, the method described in this specification illustrate elements of the various steps in an exemplary order, and the order is not limited to the specific order that is illustrated.

Each example/embodiment described in this specification may be used independently, or used in combinations, or switched and used for execution. In addition, providing predetermined information (for example, providing “being X”) is not limited to explicit notification, and may be implicit (for example, not providing the predetermined information).

The present invention is described above in detail, however, it may be apparent to those skilled in the art that the present invention is not limited to the embodiments described in this specification. Various variations and modifications may be made without departing from the scope of the present invention determined by recitations of the claims. The description in this specification is exemplary, and the description in no way limits the scope of the present invention.

### DESCRIPTION OF THE REFERENCE NUMERALS

100 Base Station
110 Transmission Part
120 Reception Part
130 Setting Information Management Part
140 Random Access Control Part
200 User Apparatus
210 Transmission unit
220 Reception Part
230 Setting Information Management Part
240 Random Access Control Part

1. A user equipment comprising:
a random access control unit for deciding whether a condition that same transmission power is usable when changing a transmission beam and retransmitting a preamble is satisfied, and determining transmission power of the preamble based on the deciding; and
a transmission unit for transmitting the preamble using the determined transmission power.

2. The user equipment as claimed in claim 1, wherein
the condition includes a condition that a number of times the preamble is transmitted using the same transmission power is less than or equal to a specified number of times, or a condition that the number of times the preamble is transmitted during a random access procedure is less than or equal to the specified number of times, and
the random access control unit increases the transmission power of the preamble in a case in which the specified number of times is exceeded when the transmission beam is changed and the preamble is retransmitted.

3. The user equipment as claimed in claim 2, wherein the random access control unit permits retransmission of the preamble until a number of retransmissions of the preamble after the specified number of times is exceeded reaches a specified number of retransmissions, or until the transmission power of the preamble exceeds a specified transmission power after the specified number of times is exceeded.

4. The user equipment as claimed in claim 1, wherein
the condition includes a condition that the transmission power of the preamble is less than a maximum transmission power, or a condition that the transmission power of the preamble is less than a specified transmission power, and
the random access control unit decreases the transmission power of the preamble, in a case in which the transmission beam is changed and the preamble is retransmitted after the transmission power of the preamble reaches the maximum transmission power or the specified transmission power.

5. A random access control method to be implemented in a user equipment, comprising steps of:
deciding whether a condition that same transmission power is usable when changing a transmission beam and retransmitting a preamble is satisfied, and determining transmission power of the preamble based on the deciding; and
transmitting the preamble using the determined transmission power.

6. A user equipment comprising:
a random access control unit for deciding whether a number of times a preamble is retransmitted using a maximum transmission power is less than or equal to a specified number of times; and
a transmission unit for transmitting the preamble when the number of retransmissions of the preamble using the maximum transmission power is less than or equal to the specified number of times.

7. The user equipment as claimed in claim 2, wherein
the condition includes a condition that the transmission power of the preamble is less than a maximum transmission power, or a condition that the transmission power of the preamble is less than a specified transmission power, and
the random access control unit decreases the transmission power of the preamble, in a case in which the transmission beam is changed and the preamble is retransmitted after the transmission power of the preamble reaches the maximum transmission power or the specified transmission power.

8. The user equipment as claimed in claim 3, wherein
the condition includes a condition that the transmission power of the preamble is less than a maximum transmission power, or a condition that the transmission power of the preamble is less than a specified transmission power, and
the random access control unit decreases the transmission power of the preamble, in a case in which the transmission beam is changed and the preamble is retransmitted after the transmission power of the preamble reaches the maximum transmission power or the specified transmission power.
